(19) United States
(12) Patent Application Publication
(10) Pub. No.: US 2024/0123624 A1
(43) Pub. Date: Apr. 18, 2024

(54) AUTONOMOUS ROBOTIC CUTTING SYSTEM

(71) Applicants: James Akl, Worcester, MA (US); Berk Calli, Worcester, MA (US); Roger Morton, Warrington (GB)

(72) Inventors: James Akl, Worcester, MA (US); Berk Calli, Worcester, MA (US); Roger Morton, Warrington (GB)

(21) Appl. No.: 18/377,196

(22) Filed: Oct. 5, 2023

Related U.S. Application Data
(60) Provisional application No. 63/413,739, filed on Oct. 6, 2022.

(51) Int. Cl. B25J 9/16; B25J 11/00

(52) U.S. Cl. CPC B25J 9/1697; B25J 11/0055

(57) ABSTRACT

Autonomous oxy-gas cutting of a metal substrate or surface along a cutting path employs vision feedback from camera based images of a predetermined, marked cutting path. The method for metal cutting according to the predetermined path includes identifying the path on a substrate for cutting, and computing a set of points based on iterative intervals along the path. A controller disposes a cutting torch based on a tangent to the path at each point in the set of points. The controller iteratively advances the torch based on successive points in the set of points for a complete traversal of the path. Cutting torch control involves moving an oxy-gas cutting jet along the cutting path on a metal surface for an efficient and complete cut. While traversing the cutting path, the controller regulates the surface heat pool quality by moving the torch tip at an appropriate velocity.

### RELATED APPLICATIONS

This patent application claims the benefit under 35 U.S.C. § 119(e) of U.S. Provisional Patent App. No. 63/413,739, filed Oct. 6, 2022, entitled “AUTONOMOUS ROBOTIC CUTTING SYSTEM,” incorporated herein by reference in entirety.

### BACKGROUND

Vision-based sensing has seen extensive usage in robotic welding and cutting applications due to properties of a non-invasive, high precision, yet relatively simple and inexpensive modality. Recent vision-based advancements in robotic welding include visual calibration, seam tracking, weld pool monitoring and correlation deformation detection. The ‘weld pool’ refers to the region of concentrated heat on the metal surface, also called melt pool, from which information relevant to the welding task can be extracted.

### SUMMARY

Autonomous oxy-gas cutting of a metal substrate or surface along a cutting path employs vision feedback from camera-based images of a predetermined, marked cutting path. The method for metal cutting according to the predetermined path includes identifying the path on a substrate for cutting, and computing a set of points based on iterative intervals along the path. A controller disposes a cutting torch based on a tangent to the path at each point in the set of points. The controller iteratively advances the torch based on successive points in the set of points for a complete traversal of the path. Cutting torch control involves moving an oxy-gas cutting jet or flame along the cutting path on a metal surface for an efficient and complete cut. While traversing the cutting path, the controller regulates the surface heat pool quality by moving the torch tip at an appropriate velocity. Since the desired positions of the torch tip are known—i.e., the points on the cutting path—then the controller is constrained to moving the torch tip only along the tangent vector of the cutting path curve. In this manner, the cutting path is given as a list of poses to visit. The controller then need only decide the rate at which to traverse these poses, which is expressed as the velocity along the tangent vector.

Configurations herein are based, in part, on the observation that robotic automation of tasks is increasingly employed to remove human actors from hazardous endeavors. Metal cutting and welding is an exemplary task that involves extreme heat, radiation and potentially harmful fumes that would benefit from such automation. Unfortunately, conventional approaches to automated tasks suffers from the shortcoming of highly dexterous and skill-oriented precision can be problematic to achieve in programmed logic. For example, metal recycling including scrap cutting processes are difficult to automate because of the widely varied nature of scrap metal pieces and the difficult of anticipating cutting scenarios to be anticipated. Automated welding, often used for new goods, enjoys precise specifications of the stock to be welded. Dismantling on the other end of the product lifecycle, in contrast, occurs with indeterminate materials and conditions. Oxy-fuel (oxygen gas driven cutting torches) applied to scrap metal encounter metal of different thicknesses and shapes. Cutting speed of the oxy-fuel torch needs to be controlled to ensure accurate and complete cutting. Accordingly, configurations herein substantially overcome the shortcomings of robotic cutting approaches by employing a camera based control rendering an image of a heat pool of the cut for regulating a cutting speed based on a convexity and intensity shown in the image, and following a cutting path according to a predetermined pattern scanned from the metal cutting surface.

In further detail, a method for actuating a robotic cutting torch as disclosed herein includes directing a cutting torch on predetermined cutting path along a metal surface, and receiving an image of a heat pool defined by engagement of the cutting torch with the metal surface. The robotic actuator controls a speed of the cutting torch based on a convexity and intensity of the heat pool computed from the image.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a robotic cutting environment suitable for use with configurations herein;

FIG. 2 shows a process flow undertaken by the robot of FIG. 1;

FIG. 3 shows traversal of a cutting path along a metal surface for cutting using the apparatus of FIG. 1;

FIGS. 4A-4E show intensity groups computed using the approach of FIGS. 1-3; and

FIGS. 5A-5C show an image of a combustion region of the torch of FIGS. 1-4 illustrating convexity and intensity.

### DETAILED DESCRIPTION

The use of robots in industrial applications contributes significantly to productivity growth in the aggregate economy. Increased adoption of industrial robots is shown to improve worker safety and reduce the global ecological footprint. As the demand for major metals is projected to increase, their associated industrial operations become ever more important. In particular, the automation of metal cutting can substantially benefit cutting-intensive sectors such as manufacturing and metal scrap recycling—the latter of which includes ship-breaking (breaking large metal structures down to smaller fragments) and results in more energy-efficient steel production as compared to iron ore processing. Metal cutting technologies and their associated robots are diverse and carry distinct advantages and limitations. Configurations discussed below automate oxy-fuel cutting operations employing a combustion-based thermal cutting medium.

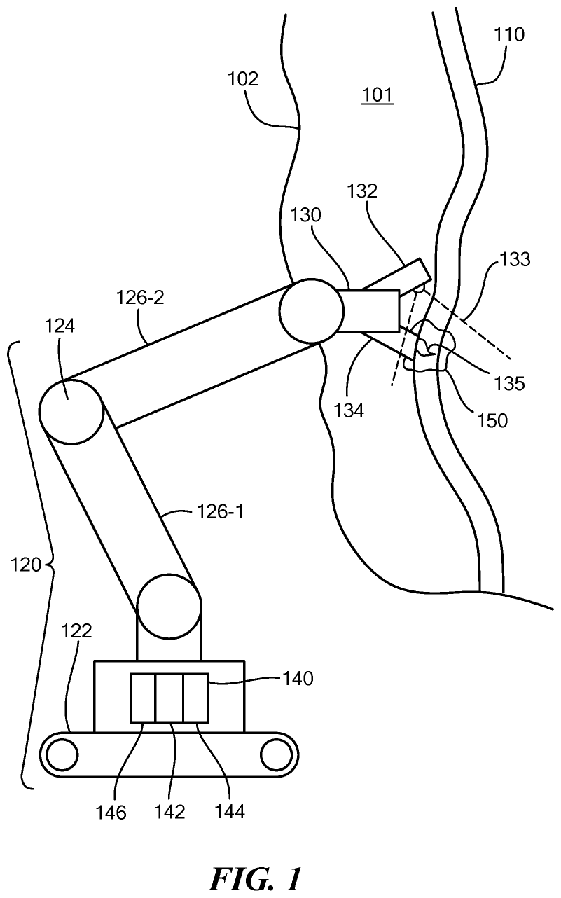

FIG. 1 is a context diagram of a robotic cutting environment suitable for use with configurations herein. Referring to FIG. 1, a mobile actuator 120 includes a drive 122 such as a set of tracks and a robotic arm 124 including one or more robotic members 126-1 . . . 126-2 (126 generally) for approaching an object 102 defining a salvage article and a proposed cutting path 110. An end effector 130 attaches to an end of the robotic arm 124 and includes an optical sensor or camera 132 and a cutting tool or torch 134. The camera 132 receives an image 133 of a heat pool 150, defined by engagement of a flame 135 or combustion source of the cutting torch 134 with the metal surface 101. The torch 134 is adapted to follow the predetermined cutting path 110 along the surface 101 of a scrap object 102. The flame 135 is adapted to sever the material composing the salvage article by attaining a combustion temperature sufficient to melt and cut the metal surface 101.

A robotic controller 140 in the mobile actuator 120 includes an image processor 144 for receiving images 133 of the heat pool 150. Cutting logic 142, includes instructions for analyzing the images and directing the end effector 130 or robotic grip holding the torch 134, using a processor 146 including power supplies and memory.

In operation, the mobile actuator 120 traverses the predetermined cutting path 110 for directing the cutting torch 134 on the predetermined cutting path 110 along the metal surface 101. The cutting path 110 has been previously scanned based on a painted or visual line on the metal surface 101, as described in co-pending U.S. patent application Ser. No. 18/119,547, filed Mar. 9, 2023, entitled “FEATURE DRIVEN NEXT VIEW PLANNING OF 3-DIMENSIONAL SURFACES,” incorporated herein by reference in entirety. It then passes the cutting tool 134 along a curve defined by a set of points defining the cutting path 110, where the cutting tool 134 is responsive to the actuator 130. The actuator 130 is advanced by the cutting logic 142 for controlling a speed of the cutting torch 134 based on a convexity and intensity of the heat pool computed from the image.

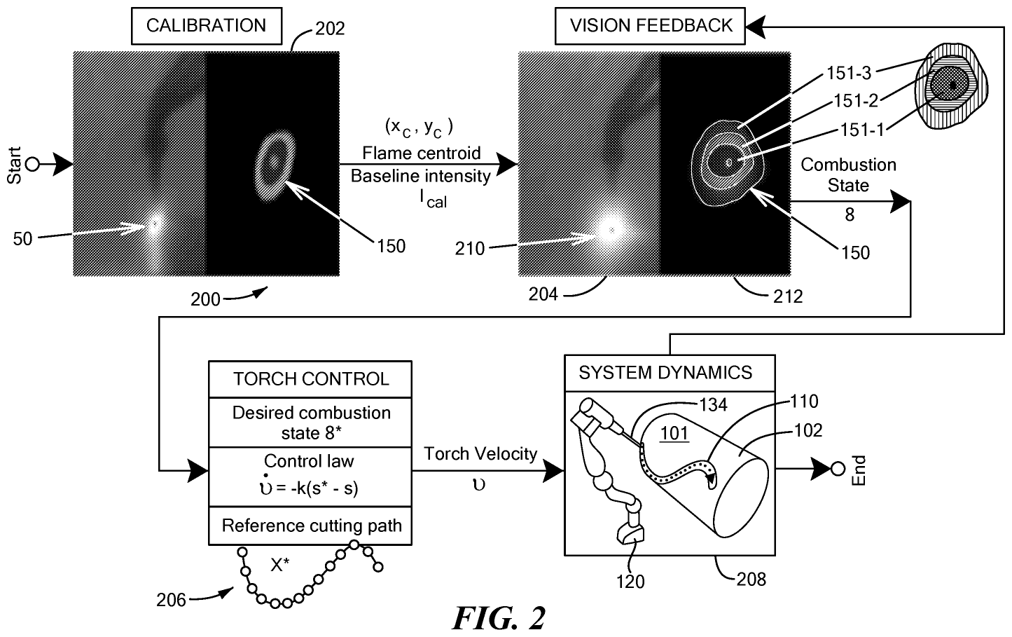

FIG. 2 shows a process flow undertaking by the robot of FIG. 1. A vision-based control approach illustrated in FIG. 2 performs autonomous combustion cutting using an oxy-fuel torch 134. This approach is inspired by the techniques of skilled cutting workers, particularly in ship-breaking yards. A conventional worker tracks the formation and evolution of the heat pool 150 at the engagement 50 of the flame 135 with the metal surface 101 to adjust their torch motions for successful cutting. The disclosed approach implements a vision system that encodes the visual characteristics (shape, size, brightness, and color) of the heat pool 150 by computing two features: the heat pool's convexity and intensity. These two features are combined to describe the heat pool's combustion state, which is utilized for controlling torch 134 motion. An example configuration implements a vision-based control approach for a 1-DOF cutting robot as in FIG. 1. Any suitable robot may be employed for following the predetermined cutting path 110 while grasping the torch 132.

Referring to FIGS. 1 and 2, a cutting operation 200 commences with calibration, at step 202, which detects the torch flame 135 and records its centroid by averaging centroid coordinates of a maximum heat region for a stable torch flame across a set number of frames, and records an intensity to be used as a baseline for subsequent measurements. Vision feedback is established, as shown at step 204, initially by maintaining the torch flame 135 at an initial position on the cutting path 110 to heat the metal surface 101. As the heat pool 150 forms and evolves, the pool is monitored until it is adequate for combustion. A filtered image 210 depicts the intensity based on the centroid of the flame 135. A color map 212 shows colored or shaded regions based on temperature ranges around the centroid. The regions 151-1 . . . 151-3 (151 generally), depict temperature ranges of the heat pool 150, where the region 151-1 of highest temperature is rendered on a blue channel (and also includes the centroid), surrounded by a green region 151-2 of lower temperature, and an outermost red region 151-3. Torch control based on the cutting logic 142 involves advancing the torch 134 to traverse the cutting path 110 by regulating the velocity to maintain the desired heat pool 150 combustion indicated by the image 133, as depicted at step 206. The torch 134 continues traversing the surface 101 at a forward speed based on the cutting logic 142 operating in an iterative feedback loop, depicted at step 208.

A particular advantage of the disclosed approach is accommodation of varying thicknesses of the metal surface 101. The actuator 130 performs a cut by advancing the torch 134 over the metal surface 101 of a first thickness, and then advances the torch 134 over a metal surface of a second thickness different than the first thickness by adjusting only the cutting speed for maintaining the intensity between the upper intensity and a lower intensity, and maintaining the convexity above the convexity minimum.

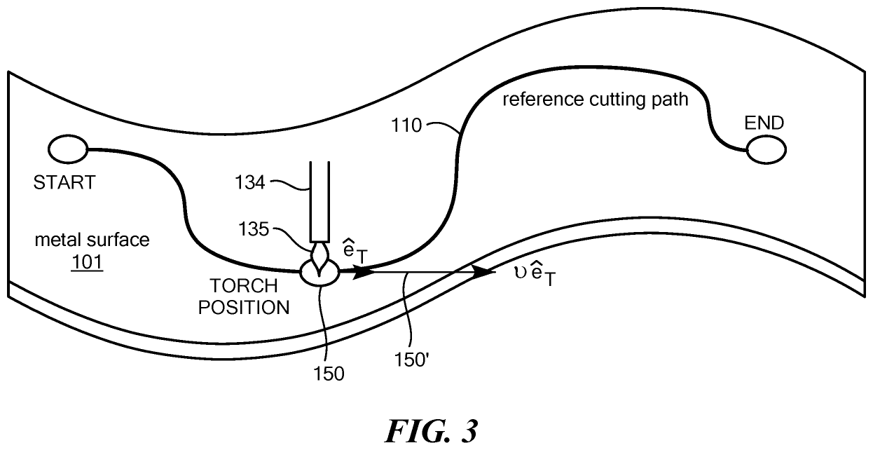

FIG. 3 shows traversal of a cutting path along a metal surface for cutting using the apparatus of FIG. 1. Referring to FIGS. 1-3, configurations herein demonstrate decoupling the torch control problem from the motion planning and control tasks of the actuator 134. The robot 120 achieves this by formulating and solving the torch control problem in a specific task space. In effect, the cutting logic 142 expects that the cutting path 110 is predetermined by an appropriate cutting path generation approach, discussed in the co-pending patent application cited above. The forward motion keeps the torch 134 orthogonal to the metal surface 101 while traversing the cutting path 110, shown by normal vector 150′. The 3D cutting path of the robot is assumed given, and the purpose of the vision-based cutting logic is then to determine the cutting speed, i.e., the torch flame's tangential velocity at which the robot traverses the cutting path 110.

Significantly, this cutting speed determines the success of the cutting operation, setting a fixed cutting speed does not guarantee successful cuts, since the speed must be regulated per the surface's combustion conditions.

As such, the visual feedback provided to the controller is a heat pool combustion state descriptor s computed from the camera's RGB feed. Specifically, the camera images are processed (simplified and filtered) after which two heat pool features (convexity and intensity) are used to compute forward speed. It might be intuitively expected that the slow cuts fully penetrate each plate along the cutting path. In actuality, moving the torch too slowly accumulates heat excessively in regions surrounding the cutting path thereby re-sealing portions of the cut with creeping deposits of heated steel.

Conventional approaches do not employ a vision-based controller that regulates the combustion state by updating the torch speed, while maintaining a consistent height and tangent pose above the cutting surface. Configurations herein demonstrate that the method can successfully cut steel plates of different thicknesses relying only on visual feedback without a priori knowledge about the thicknesses.

The control problem consists of moving the torch's flame jet along a reference spatial path on a metal surface, such that the cut is bot successful and efficient. The controller must regulate the surface heat pool's combustion state while traversing the cutting path by moving the torch tip at an appropriate velocity.

Particular configurations assume that this cutting path is predetermined by a suitable cutting path generation method and that the torch tip is kept normal to the metal surface while moved along this path. Torch control focuses on determining the cutting speed, i.e., the velocity at which the torch is moved along this path 110. Moving the torch at adequate cutting speeds is important for successful cutting. It should be emphasized that the vision-based cutting logic 142 does not use any a priori information about the plate thickness or temperature and relies purely on visual feedback.

Since the desired torch tip positions are known from the points on the reference cutting path 110, then the controller 140 is constrained to moving the torch tip only along the tangent vector of the curve. Essentially, the reference path is a sequence of torch tip positions to visit wherein the controller determines the rate at which to traverse these positions, expressed as the velocity along the tangent vector 150′ of FIG. 3.

The cutting logic 142 sets the acceleration along the path's tangent vector 150′ (updating the velocity) using visual feedback from the RGB camera. Expressing the control action along the local tangent vector decouples the combustion control problem from the robot motion planning problem. In general settings, the tangential motion commands can be resolved into joint space via the system's inverse kinematics.

As the purpose of the cutting logic 142 is to maintain a sufficient combustion for cutting, the visual feedback from the camera 132 should be designed to describe the heat pool's combustion state. It should be noted that excessive combustion indicates an overly slow torch velocity, while deficient combustion indicates an overly fast velocity, and an adequate velocity leads to a desired combustion state. The extracted visual features must then reflect this negative relationship between cutting speed and combustion state.

As such, the visual feedback provided to the controller is a heat pool combustion state descriptor s computed from the camera's RGB feed. Specifically, the camera images 133 are processed (simplified and filtered) after which two heat pool features (convexity and intensity) are computed and combined to describe the pool's combustion state s.

The image is simplified such that the heat pool's features are emphasized. The features of interest are visual surrogates for shape and temperature. In the heat pool, the color distribution of light emissions can be used to estimate a relative temperature profile. This is because visible light of higher frequencies is emitted at higher energy states. The cutting logic 142 restricts the RGB color space to four discrete colors listed in order of decreasing temperature: blue, green, red, and black, however any suitable number of tiers or temperature thresholds could be employed. In this discretized color space, blue light emissions correlate with the highest temperatures (higher electromagnetic frequency), green light with moderate temperatures (intermediate frequency), and red light with the lowest temperatures (lower frequency). Black denotes low light emissions and thus negligible temperatures for purposes of metal cutting.

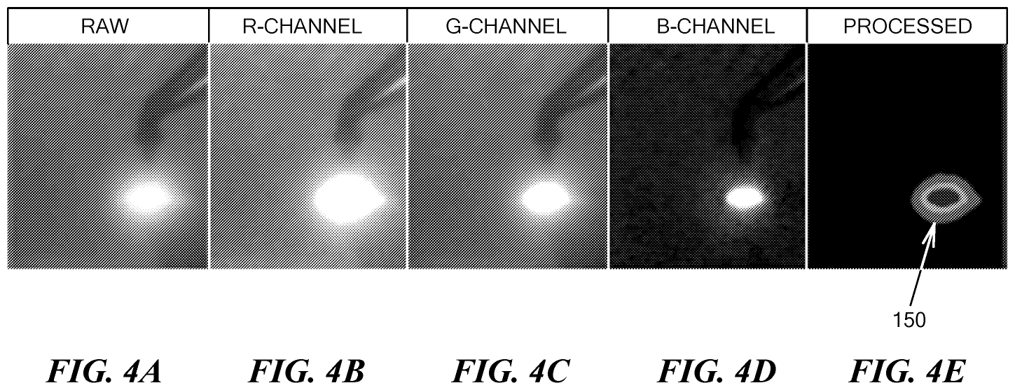

This phenomenon is illustrated in FIGS. 4A-4E, depicting a raw camera image and its color channels. Referring to FIGS. 1-3 and 4A-4E, the highest heat intensity is nearest to the flame center (FIG. 4A), and decays with distance. In effect, the blue channel's (FIG. 4D) highest brightness is nearest to the pool center, whereas the green (FIG. 4C) and red (FIG. 4B) channels include moderate and lower temperature portions of the pool.

With this, the raw images 133 are processed as follows:
Binary-threshold each channel using high cutoffs;
Color each channel's non-zero pixels (red, green, blue);
Eliminate channel overlap via XOR operations;
Merge the channels, yielding a segmented heat pool, shown in FIG. 4E with varying shades show the respective tiers of temperature exhibited by the heat bool 150.

This simple and efficient channel-wise thresholding procedure emphasizes the pool's geometric and thermal information. The shape and size of the pool is preserved and its color information is quantized as the image contains only four colors. This enables efficient representation and tractable reasoning about the heat pool 150, its convexity features, and its combustion.

Each image of the heat pool 150 therefore denotes a plurality of temperature regions 151, such that each temperature region is indicative of a temperature threshold. In the respective shaded regions, each temperature region defines a set of pixels in the image denoting a temperature above a threshold, such that all pixels in the temperature denote a temperature greater than the threshold. Depending on the thresholds, the temperature region 151 denotes a group of pixels designating a range of temperature values between a threshold minimum and a threshold maximum, with the centermost (containing the centroid) having the greatest temperature.

From the image of the regions, convexity and intensity are computed. Utilizing the processed image, the cutting logic 142 defines measure of the pool's shape using its convexity. During cutting, when the pool's shape is relatively more convex, then the surface conditions are more adequate for combustion. Conversely, when the pool's shape is more concave or exhibits significant convexity defects, then the surface conditions are more adverse for combustion. This is since a higher relative convexity is indicative of heat that is more concentrated in the heat pool. While there are sophisticated approaches to quantify a closed contour's convexity, the cutting logic 142 computes the area ratio between the pool contour against its convex hull. Formally, let K be the contour of the heat pool in the image; this is a set of pixel coordinates of the simple closed curve. We define the pool convexity as c=|K|/| conv K| where |K| denotes the area of the contour and | conv K| the area of its convex hull. This yields the following desirable properties: (1) c∈(0, 1] where c=1 is a perfectly convex shape. A higher value of c denotes a higher convexity and thus correlates with a higher combustion state. The ratio c is invariant to pool's size or color, it only quantifies its shape. More precisely, it is dimension-invariant, pose-invariant, and color-invariant.

In practice, restricting the contour K to the hottest layer in the pool, i.e., the pool's blue, or innermost, channel, yields more robust convexity values. Moreover, K is retrieved computationally as the largest contour closest to the torch flame centroid (obtained previously from the calibration step).

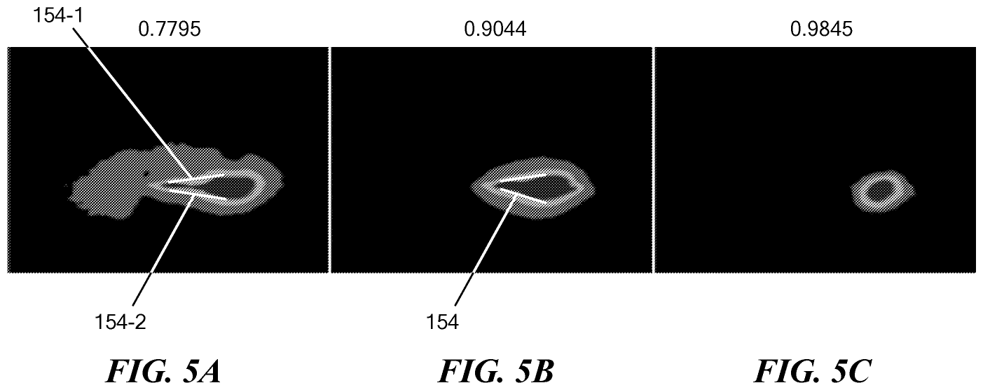

FIGS. 5A-5C show an image of combustion regions of the torch of FIGS. 1-4E illustrating convexity and intensity. In general, the heat pool image indicates a temperature region 151, such that the convexity is based on a percentage of the temperature region occupying a bounding hull around the region. FIG. 5A shows an rough ellipsoid heat pool 150. Using the innermost region, corresponding to the blue channel, a line is banded around the perimeter, as if an elastic band were applied around the perimeter. Concave regions 154-1, 154-2 (154 generally) detract from convexity, such that convexity is a percentage of the banded area occupied by the blue channel region, i.e. the area of the concave regions 154 represent the percentage of area detracting from 100% convexity, yielding a value of about 78%. FIG. 5B defines a greater convexity, and a more rounded, less oblong shape is consistent with a single, small concavity region 154 for a convexity of about 90%. FIG. 5C appears substantially round and has a correspondingly high convexity of around 98%. In practice, restricting the contour K to the hottest layer in the pool, i.e., the pool's blue channel, yields more robust convexity values. Moreover, K is retrieved computationally as the largest contour closest to the torch flame centroid.

Once convexity is computed, the intensity of the heat pool follows. Intensity is computed by grouping pixels in each region and applying a weighting to each group of pixels. The weighted pixels are then aggregated according to a radial decay for computing the intensity. The pool intensity is designed to convey, from the processed image, the pool's color and size. The pool intensity computation is summarized below and elaborated thereafter:
Weigh pixels based on color (black, red, green, blue).
Weigh pixels via a radial decay function centered at the torch flame's centroid (obtained from calibration).
Sum all weighted pixels to yield an unscaled intensity.
Scale the sum by the calibration baseline, apply a saturation cutoff, and normalize to yield the pool intensity.

The first step in intensity computation approximates the relative temperature differences in the quantized color space. This captures size (total non-zero pixels) and color (via weights). The second step approximates the nonlinear radial decay effects of heat transfer, i.e., the heat at a pixel decays quickly with distance from the torch flame's centroid. Moreover, this radial decay provides robustness against noise and undesirable effects such as: (1) light pollution, (2) sudden sparks, slag, or streaks, and (3) residual heated regions away from the heat pool. Here, a bivariate Gaussian function is appropriate as it models radial exponential decay using simple parameters.

Formally, let M be the processed image in an array form, which contains pixels p considered tuples (xₚ, yₚ, color(p)) containing the pixel coordinates and color. The 2D Gaussian function g(p) assigns a decay factor to each pixel based on its distance from the torch flame centroid (x_{c}, y_{c}), which is determined at calibration. The color-weighing function w(p) assigns a constant weight based on the pixel's color. The functions g(p) and w(p) as:

$$g ( p ) = exp [ - \frac{{( {x}_{p} - {x}_{c} )}^{2}}{2 {σ}_{X}^{2}} - \frac{{( {y}_{p} - {y}_{c} )}^{2}}{2 {σ}_{Y}^{2}} ]$$

$$w ( p ) = \{ \begin{matrix}0 , & if color ( p ) = Black \\ {w}_{R} , & if color ( p ) = Red \\ {w}_{G} , & if color ( p ) = Green \\ {w}_{B} , & if color ( p ) = Blue\end{matrix}$$

Here, σ_{X} and σ_{Y} determine the radial decay rate in each axis. The weights w_{R}<w_{G}<w_{B} are constants. Using these definitions, an absolute sum is defined as:

I=p∈M g(p)w(p).

In the disclosed approach, α_{X}=σ_{Y}=30 px and (w_{R}, w_{G}, w_{B})=(0.01, 0.04, 0.16) to approximate the nonlinear temperature differences between colors.

At calibration, we perform these intensity computations and obtain a baseline intensity value I_{cal} against by which all other intensities are scaled. Let Γ=I/I_{cal} be the intensity expressed relative to this baseline. This expresses the intensities with a physical meaning, for instance Γ=1 is an intensity equal to that of the torch flame, while Γ=5 is an intensity five times greater. This simplifies the interpretation of intensity values and the tuning of desired intensity values.

To design a pool combustion state descriptor, the pool intensity must be normalized for combination with the pool convexity. For this, a saturation intensity/That is set to be greater than the maximum values of Γ observed during trial cutting runs. In the disclosed approach Γsat=10, i.e., intensity saturates at 10 times the baseline. We thus normalize the pool intensity as i=min(Γsat, Γ)/Γsat with i∈(0, 1].

Finally, the pool combustion state descriptor is defined as s=λc+(1−Δ)i where the relative emphasis on pool convexity or pool intensity is tuned with λ∈[0, 1]. This yields a desirable normalized state descriptor s∈(0, 1]. In our experiments, we set λ=½. This descriptor, by design, captures the positive relationship between convexity and combustion state (whereby a higher convexity indicates more concentrated combustion), and the positive relationship between intensity and combustion state (whereby a higher intensity indicates a stronger combustion).

In operation, the combustion control task performed by the cutting logic 142 assumes that calibration and conditioning are completed, meaning that the torch flame's centroid and baseline intensity are determined (so that combustion state s is computable) and that the metal surface is sufficiently preheated for combustion to take place.

The cutting logic may proceed under the following assertions:
The pose transform between the torch flame and cam-era is fixed: The camera is rigidly attached to the torch, observing its tip from a fixed viewpoint throughout cutting and keeping the torch flame stationary in the image frame. After calibration, the torch flame's centroid in the image frame does not change.
The pool combustion state and torch speed have a negative relationship: The pool combustion state is highly correlated with the pool's temperature. A faster torch speed reduces the amount of heat transferred to the local metal surface, thereby yielding a lower pool temperature and therefore a lower pool combustion state. This is also confirmed empirically using a cutting torch and metal plates. The pool combustion state drops at higher torch speeds, and increases at lower ones. Note that the combustion state is taken to be an instantaneous measure of the most immediate pool, and does not concern residual heated regions elsewhere on the surface.
There exists a desired speed at which the desired combustion state is maintained: This results from the negative relationship between combustion state and torch speed. Moving the torch too fast produces deficient pool combustion, yielding poor or no cuts. Conversely, moving too slow produces excessive combustion, yielding inefficient and badly textured cuts. There is a range of intermediate speed values yielding adequate combustion among which exists a desired pair for speed and combustion state.

In general, controlling the cutting speed includes decreasing the cutting speed when the convexity decreases, and increasing the cutting speed when the convexity increases. When the thickness of the cutting surface is substantially constant, the cutting logic 142 may maintain the cutting speed at a rate that achieves an intensity between an upper intensity and a lower intensity for performing a complete cut at a convexity above a convexity minimum. And this occurs while maintaining an emission angle of the torch at a position normal to the metal surface and at a substantially constant height above the metal surface.

Looking further into actual deployment, the robotic scrap metal cutting device employs a robotic actuator 130, and a cutting torch 134 attached to the actuator and responsive to the actuator for movement predetermined cutting path 110 along a metal surface 101. The camera 132 is positioned for receiving an image 133 of the heat pool 150, such that the heat pool is defined by engagement of the cutting torch with the metal surface. Cutting logic 142 for controls a speed of the cutting torch based on the convexity and intensity of the heat pool computed from the image 133, and iterates in a control loop for continually updating the forward cutting speed, typically varying based on the thickness of the cutting surface 101.

We formally define the variables for heat source's tangential velocity and the heat pool combustion state as follows:
v(t) ∈R_{≥0} is the tangential velocity of the heat source (torch flame centroid) on the reference cutting path.
s(t)=ϕ(v(t))∈R_{> 0} is the pool combustion state in the image frame, where ϕ models the map from v to s.
s* is the desired state and v* is the desired velocity.

The function ϕ:v1→s maps from the torch velocity to the combustion state and thus admits the following conditions:
ϕ is strictly positive: ϕ(v)>0, ∀v∈R_{≥0}. This is since s>0 due to c, i>0 as defined above.
ϕ is monotonically decreasing with respect to v:
^{d}/dvϕ(v)<0, ∀v(t) such that lim ϕ(v)=0 as v→∞.
ϕ admits the desired-velocity constraint ϕ(v*)=s*.
   The control input is the tangential acceleration v\dot{ }(t) updating the velocity v of which the state s is a function. We thus control combustion state via acceleration. The implication of ϕ(v*)=s* is that by tracking s*, the torch is moved at the desired velocity v*. Let eₛ(t)=s*−s(v(t)) be the combustion state error with respect to the desired state s*. Its dynamics are: e\dot{ }ₛ(t)=−^{d}dv s(v)v\dot{ }(t). Apply the control input v\dot{ }(t)=−keₛ(t) with k>0 being a strictly positive gain. This results in the desired behavior of accelerating when s is excessive and decelerating when s is deficient. Substitute tin the dynamics equation to obtain:

$${\dot{e}}_{s} \vert ( t ) = {ke}_{s} ( t ) \frac{d}{dv} s ( v )$$

Stability may be shown using the Lyapunov candidate function:

$$V ( {e}_{s} ) = \frac{1}{2} {e}_{s}^{2} ,$$

computing its derivative:

$$\dot{V} ( {e}_{s} ( t ) ) = {e}_{s} {\dot{e}}_{s} = {ke}_{s}^{2} ( t ) \frac{d}{dv} \vert s ( v ) < 0 , ∀ {e}_{s} ( t ) \neq 0$$

The above result is true for all non-zero error states since

$$k > 0 , and {e}_{s}^{2} ( t ) > 0 , and \frac{d}{dv} s ( v ) = \frac{d}{dv} ϕ ( v ) < 0$$

The controlled system is thus asymptotically stable.

It should be noted that the desired combustion state s* is determined experimentally. Specifically, an adequate range of combustion states is found for a particular setup and would not change across cutting sessions. After a certain number of trials, a precise value for the desired state s* is determined.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as solid state drives (SSDs) and media, flash drives, floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions, including virtual machines and hypervisor controlled execution environments. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method for actuating a robotic cutting torch, comprising:
directing a cutting torch on predetermined cutting path along a metal surface;
receiving an image of a heat pool, the heat pool defined by engagement of the cutting torch with the metal surface; and
controlling a speed of the cutting torch based on a convexity and intensity of the heat pool computed from the image.

2. The method of claim 1 wherein the image of the heat pool denotes a plurality of temperature regions, each temperature region indicative of a temperature threshold.

3. The method of claim 2 further comprising computing the intensity by:
grouping pixels in each region;
applying a weighting to each group of pixels; and
aggregating the weighted pixels according to a radial decay for computing the intensity.

4. The method of claim 1 wherein the heat pool image indicates a temperature region, the convexity based on a percentage of the temperature region occupying a bounding hull around the region.

5. The method of claim 1 wherein the temperature region defines a set of pixels in the image denoting a temperature above a threshold, such that all pixels in the temperature denote a temperature greater than the threshold.

6. The method of claim 1 wherein the temperature region denotes a group of pixels designating a range of temperature values between a threshold minimum and a threshold maximum.

7. The method of claim 4 further comprising decreasing the cutting speed when the convexity decreases.

8. The method of claim 4 further comprising increasing the cutting speed when the convexity increases.

9. The method of claim 1 further comprising maintaining the cutting speed at a rate that achieves an intensity between an upper intensity and a lower intensity for performing a complete cut at a convexity above a convexity minimum.

10. The method of claim 1 further comprising maintaining an emission angle of the torch at a position normal to the metal surface and at a substantially constant height above the metal surface.

11. The method of claim 9 further comprising:
performing a cut by advancing the torch over a metal surface of a first thickness;
advancing the torch over a metal surface of a second thickness different than the first thickness; and
adjusting the cutting speed for:
maintaining the intensity between the upper intensity and a lower intensity, and
maintaining the convexity above the convexity minimum.

12. The method of claim 1 further comprising filtering the image based on a distance from a centroid of the highest temperature pixels.

13. A robotic scrap metal cutting device, comprising:
a robotic actuator;
a cutting torch attached to the actuator and responsive to the actuator for movement predetermined cutting path along a metal surface;
a camera for receiving an image of a heat pool, the heat pool defined by engagement of the cutting torch with the metal surface; and
cutting logic for controlling a speed of the cutting torch based on a convexity and intensity of the heat pool computed from the image.

14. The device of claim 13 wherein the robotic actuator is adapted to dispose the cutting torch at a position normal to the cutting surface and at a predetermined height above the cutting surface for advancing the torch in a direction parallel to a tangent to the cutting surface.

15. The device of claim 12 wherein the cutting surface is metal and the cutting torch is an oxy-fuel torch.

16. A computer program embodying program code on a non-transitory computer readable medium that, when executed by a processor, performs steps for implementing a method of e actuating a robotic cutting torch, the method comprising:
directing a cutting torch on predetermined cutting path along a metal surface;
receiving an image of a heat pool, the heat pool defined by engagement of the cutting torch with the metal surface; and
controlling a speed of the cutting torch based on a convexity and intensity of the heat pool computed from the image.
